(19) United States
(12) Patent Application Publication
(10) Pub. No.: US 2022/0034326 A1
(43) Pub. Date: Feb. 3, 2022

(54) AIR CIRCULATOR HAVING DUAL ROTARY VANE

(71) Applicant: MIRO CO., LTD., Incheon (KR)

(72) Inventors: Dong Jin SEO, Incheon (KR); Yong Ju OH, Incheon (KR); Min Seok KIM, Incheon (KR)

(21) Appl. No.: 17/279,495

(22) PCT Filed: Jan. 21, 2020
(86) PCT No.: PCT/KR2020/001012

§ 371 Date: Mar. 24, 2021

(30) Foreign Application Priority Data
Jan. 31, 2019 (KR) 10-2019-0013080
Dec. 20, 2019 (KR) 10-2019-0171649

(51) Int. Cl. F04D 19/00; F04D 25/16; F04D 25/08; F04D 29/32

(52) U.S. Cl. CPC F04D 19/002; F04D 29/325; F04D 25/08; F04D 25/166

(57) ABSTRACT

An air circulator having a dual rotary vane according to an exemplary embodiment of the present invention includes: a casing assembly having a suction port through which air is introduced, and a discharge port through which the air is discharged; an intake fan assembly including an intake motor fixedly coupled in the casing assembly, and an intake fan configured to be rotatably driven by the intake motor; and an exhaust fan assembly including an exhaust motor fixedly coupled in the casing assembly, and an exhaust fan configured to be rotatably driven by the exhaust motor, in which a rotational speed of the exhaust fan is higher than a rotational speed of the intake fan.

### TECHNICAL FIELD

The present invention relates to an air circulator, and more particularly, to an air circulator having a dual rotary vane, the air circulator having two fans including an intake fan having a rotary vane with a large diameter and an exhaust fan having a rotary vane with a small diameter, thereby improving straightness of an air flow and air blowing efficiency.

### BACKGROUND ART

An axial flow fan refers to a fluid machine having a plurality of rotary vanes radially arranged around a hub and configured to blow air in an axial direction of the rotary vanes by being rotated by a motor or the like. Typically, examples of the axial flow fan include an electric fan, a ventilator for indoor ventilation, or a cooling fan for blowing heat dissipation air to an air-cooled heat exchanger such as a radiator or a condenser for a vehicle in order to promote dissipation of heat from the heat exchanger.

In particular, an axial flow fan, which is mounted on a heat exchanger of an air conditioner for a vehicle, is surrounded by a bell mouth type ventilation port, and the axial flow fan is mounted on a rear surface or a front surface of the heat exchanger together with a shroud having a stator capable of guiding blowing air in an axial direction from a front surface or a rear surface of the ventilation port. The above-mentioned axial flow fan for an air-cooled heat exchanger for a vehicle is classified into a pusher type axial flow fan and a puller type axial flow fan depending on the form in which the axial flow fan is placed on the heat exchanger.

However, because the general axial flow fan in the related art has a structure having a single rotary vane, there is a problem in that air blowing efficiency deteriorates due to a structural limitation of the single rotary vane.

### DISCLOSURE

### Technical Problem

The present invention has been made in an effort to solve the above-mentioned problem of the axial flow fan having the single vane in the related art, and an object of the present invention is to provide an air circulator having a dual rotary vane, which improves straightness of an air flow and air blowing efficiency.

### Technical Solution

An air circulator having a dual rotary vane according to an exemplary embodiment of the present invention includes: a casing assembly having a suction port through which air is introduced, and a discharge port through which the air is discharged; an intake fan assembly including an intake motor fixedly coupled in the casing assembly, and an intake fan configured to be rotatably driven by the intake motor; and an exhaust fan assembly including an exhaust motor fixedly coupled in the casing assembly, and an exhaust fan configured to be rotatably driven by the exhaust motor and having a rotation radius smaller than a rotation radius of the intake fan, in which a rotational speed of the exhaust fan is higher than a rotational speed of the intake fan.

In this case, when the rotational speed of the intake fan is R1 and the rotational speed of the exhaust fan is R2, R1:R2 may be 1:1.5 to 1:1.7.

Alternatively, when the rotational speed of the intake fan is R1 and the rotational speed of the exhaust fan is R2, R1:R2 may be 1:1.7 to 1:2.

Alternatively, when the rotational speed of the intake fan is R1 and the rotational speed of the exhaust fan is R2, R1:R2 may be 1:2.

Alternatively, the rotational speed of the intake fan may be greater than that of the exhaust fan by 70 to 30%.

Alternatively, the rotational speed of the intake fan may be greater than that of the exhaust fan by 60 to 40%.

Alternatively, when the rotational speed of the intake fan and the rotational speed of the exhaust fan are changed so that an air blowing distance of an air flow discharged from the casing assembly is constant, a low ratio of the rotational speed of the exhaust fan to the rotational speed of the intake fan may be selected so that power consumption of the intake motor and the exhaust motor is decreased.

Alternatively, the casing assembly may have a plurality of intake holes through which outside air is introduced, and the plurality of intake holes may be formed adjacent to the suction port and disposed along an outer circumferential edge of the casing assembly.

Alternatively, the casing assembly may include: an intake fan casing configured to receive the intake fan assembly; an exhaust fan casing configured to receive the exhaust fan assembly; and a support body fixedly coupled to the intake fan casing between the intake fan casing and the exhaust fan casing and configured to fix and support the intake fan assembly and the exhaust fan assembly, and a plurality of intake holes through which outside air is introduced may be formed at one side and an outer circumferential edge of the intake fan casing.

### Advantageous Effects

The air circulator according to the present invention may blow air using the dual rotary vane, thereby improving air blowing efficiency, implementing high straightness of the air flow, and reducing power consumption.

### DESCRIPTION OF DRAWINGS

FIG. 1 is a perspective view of an air circulator having a dual rotary vane according to an exemplary embodiment of the present invention.

FIG. 2 is an exploded perspective view of the air circulator illustrated in FIG. 1.

FIGS. 3A, 3B, and 3C are schematic views illustrating results of performing experiments on straightness of air flows of the air circulator illustrated in FIG. 1.

FIGS. 4 and 5 are schematic views illustrating results of performing experiments while changing rotational speeds of an exhaust fan.

FIGS. 6A, 6B, and 6C are schematic views illustrating results of performing experiments on straightness of air flows while changing structures of a casing assembly.

FIG. 7 is a schematic view illustrating results of performing an experiment on occurrence of a vortex in accordance with a structure of the casing assembly.

### BEST MODE

Hereinafter, an exemplary embodiment of the present invention will be described in detail with reference to the accompanying drawings so that those skilled in the technical field to which the present invention pertains may easily carry out the exemplary embodiment. The present invention may be implemented in various different ways and is not limited to the exemplary embodiment described herein. In the drawings, a part irrelevant to the description will be omitted to clearly describe the present invention, and the same or similar constituent elements will be designated by the same reference numerals throughout the specification.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. In addition, when one component such as a layer, a film, a region, or a plate is described as being positioned “on” another component, one component can be positioned “directly on” another component, and one component can also be positioned on another component with other components interposed therebetween. On the contrary, when one component such as a layer, a film, a region, or a plate is described as being positioned “under” another component, one component can be positioned “directly under” another component, and one component can also be positioned on another component with other components interposed therebetween.

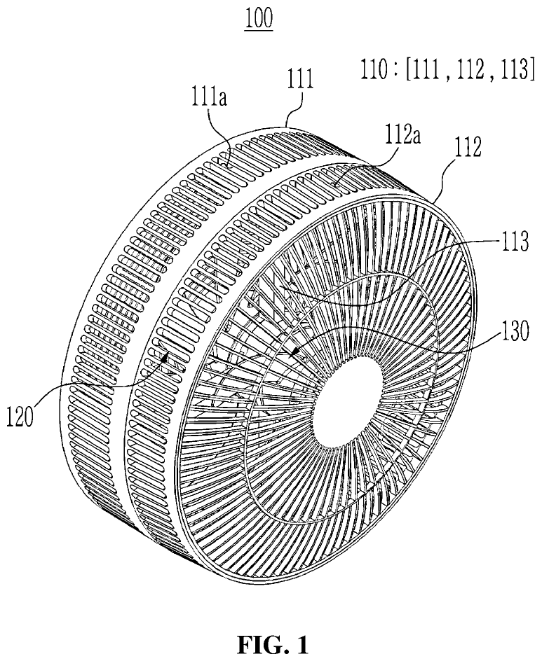

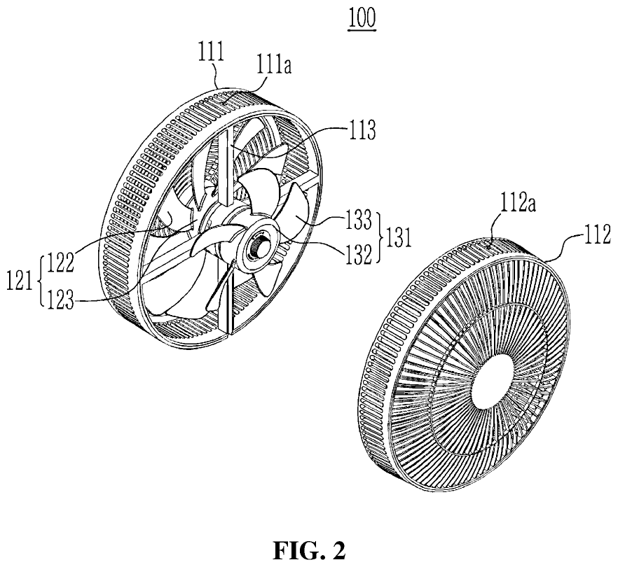

As illustrated in FIGS. 1 and 2, an air circulator 100 having a dual rotary vane according to an exemplary embodiment of the present invention may include a casing assembly 110, an intake fan assembly 120, and an exhaust fan assembly 130.

The casing assembly 110 includes two casings each having a cylindrical shape as a whole, and the two casings may include an intake fan casing 111 surrounding the intake fan assembly 120, and an exhaust fan casing 112 surrounding the exhaust fan assembly 130.

The intake fan casing 111 is manufactured to have a larger diameter than the exhaust fan casing 112 in order to surround the intake fan assembly 120 having a large diameter and has a cylindrical shape opened at one side thereof. The intake fan casing 111 has a plurality of suction ports radially formed in a rear portion through which air is introduced. In addition, the intake fan casing 111 has a plurality of intake holes 111a formed along an outer circumferential edge of the intake fan casing 111 and extending in a longitudinal direction of the intake fan casing 111. It is advantageous that the intake holes 111a are disposed as densely as possible at the outer circumferential edge of the intake fan casing 111, and it may also be advantageous that the intake hole 111a has a length as long as possible in order to facilitate the introduction of air.

The intake fan casing 111 includes a support body 113 for supporting the intake fan assembly 120 and the exhaust fan assembly 130, and the support body 113 has two rectangular support plates installed in a cross shape and fixed in the intake fan casing 111. The support body 113 may be disposed at a position distant from the suction port, that is, substantially at a center of the casing assembly 110 when the casing assembly 110 is assembled. The support body 113 may be installed in the intake fan casing 111 and have comparatively high rigidity in order to fix and support motors of the intake fan assembly 120 and the exhaust fan assembly 130. In this case, the intake fan casing 111 and the support body 113 may be separately manufactured and then coupled to each other, or the intake fan casing 111 and the support body 113 may be integrally manufactured by injection-molding the same material.

The exhaust fan casing 112 is manufactured to have a smaller diameter than the intake fan casing 111 in order to surround the exhaust fan assembly 130 having a small diameter and has a cylindrical shape opened at one side thereof. The exhaust fan casing 112 has a plurality of discharge ports radially formed in a front portion through which air is discharged. In addition, the exhaust fan casing 112 has a plurality of exhaust holes 112a formed along an outer circumferential edge of the exhaust fan casing 112 and extending in a longitudinal direction of the exhaust fan casing 112. It is advantageous that the exhaust holes 112a are disposed as densely as possible at the outer circumferential edge of the exhaust fan casing 112, and it may also be advantageous that the exhaust hole 112a has a length as long as possible in order to facilitate the discharge of the air. However, the exhaust hole 112a may be selectively formed in the exhaust fan casing 112. In the present exemplary embodiment, the plurality of exhaust holes 112a is formed in the exhaust fan casing 112, but as necessary, the exhaust fan casing 112 having no exhaust hole 112a may be used.

The exhaust fan casing 112 may be fixedly coupled to the intake fan casing 111 by means of separate fastening members, for example, bolts or clips. However, a detailed description of this configuration will be omitted because this configuration is already well known and common to those skilled in the art.

The intake fan assembly 120 serves to draw outside air through the suction ports and the intake holes 111a and may include an intake motor (not illustrated) fixedly coupled to the support body 113, and an intake fan 121 coupled to the intake motor. The intake motor rotates the intake fan 121 using driving power transmitted from the outside. In this case, the intake motor may rotate in a direction opposite to a direction of an exhaust motor. That is, the intake fan 121 and an exhaust fan 131 are rotated in opposite directions. In addition, a rotation radius of the intake fan 121 may be larger than a rotation radius of the exhaust fan 131.

The intake fan 121 includes an intake fan hub 122 fixedly coupled to a rotary shaft (not illustrated) of the intake motor, and a plurality of intake blades 123 coupled to the intake fan hub 122 and radially extending from the intake fan hub 122. It is advantageous that the intake blade 123 is larger than an exhaust blade 133, and more particularly, a rotation radius of the intake blade 123 is larger than a rotation radius of the exhaust blade 133.

The exhaust fan assembly 130 serves to discharge, to the outside, the air introduced into the casing assembly 110 by the intake blades 123 and may include the exhaust motor (not illustrated) fixedly coupled to the support body 113, and the exhaust fan 131 coupled to the exhaust motor. The exhaust motor rotates the exhaust fan 131 using driving power transmitted from the outside. In this case, the exhaust motor may rotate in the direction opposite to the direction of the intake motor. That is, the exhaust fan 131 and the intake fan 121 are rotated in opposite directions. In addition, the rotation radius of the exhaust fan 131 may be smaller than the rotation radius of the intake fan 121.

The exhaust fan 131 includes an exhaust fan hub 132 fixedly coupled to a rotary shaft (not illustrated) of the exhaust motor, and the plurality of exhaust blades 133 coupled to the exhaust fan hub 132 and radially extending from the exhaust fan hub 132. It is advantageous that the exhaust blade 133 is smaller than the intake blade 123, and more particularly, the rotation radius of the exhaust blade 133 is smaller than the rotation radius of the intake blade 123.

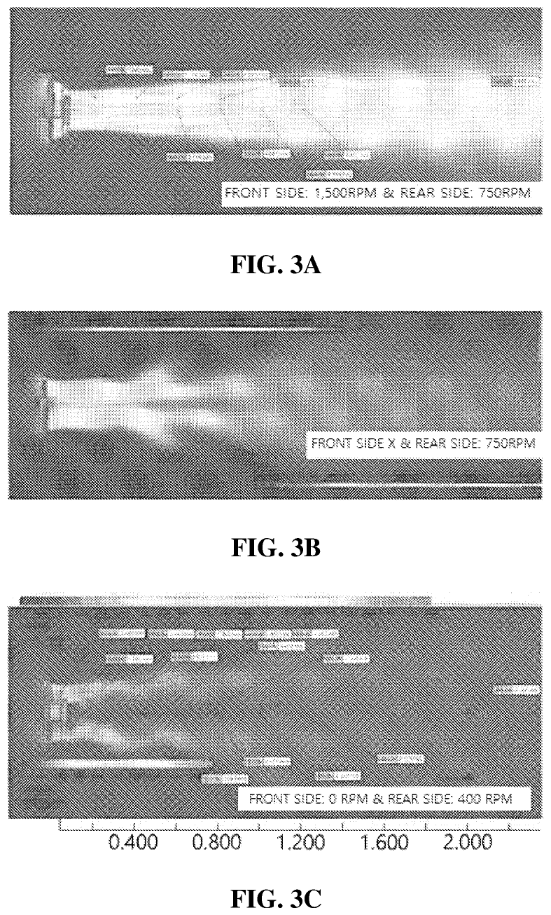

FIGS. 3A, 3B, and 3C are views illustrating results of performing experiments on straightness of air flows of the air circulator 100 according to the exemplary embodiment of the present invention. The experiments were performed on the straightness of the air flows while changing rotational speeds of the intake fan 121 and operating, not operating, and freely rotating the exhaust fan 131.

As illustrated in FIG. 3A, the rotational speed of the intake fan 121 was set to 750 RPM, the rotational speed of the exhaust fan 131 was set to 1,500 RPM, and then the straightness of the air flow was evaluated. By rotating the intake fan 121 and the exhaust fan 131 in opposite directions, the good straightness of the air flow was detected. That is, when both the intake fan 121 and the exhaust fan 131 were operated, a laminar flow was formed, such that the air flow had the straightness, and thus an air blowing distance of the air flow was increased.

As illustrated in FIG. 3B, the rotational speed of the intake fan 121 was set to 750 RPM, and then the air flow was evaluated in a state in which the exhaust fan 131 was not operated, that is, the exhaust fan 131 was stationary. In the state in which the exhaust fan 131 was stopped, the exhaust fan 131 acted as a resistance component, such that the air flow was spread, that is, a turbulent flow occurred. As such, due to the resistance caused by the exhaust fan 131, the straightness of the air flow significantly deteriorated.

As illustrated in FIG. 3C, the rotational speed of the intake fan 121 was set to 400 RPM, and then the air flow was evaluated in a state in which the exhaust fan 131 was freely rotated. In the state in which the exhaust fan 131 was freely rotated, a laminar flow was maintained to a predetermined distance, but the laminar flow was changed to a turbulent flow at a predetermined distance or more. The straightness occurred in comparison with FIG. 3B, but the straightness and the air blowing distance significantly deteriorated in comparison with FIG. 3A.

As a result, it can be ascertained from the above-mentioned experiments that when both the intake fan 121 and the exhaust fan 131 are operated, the air flow generated by the intake fan 121 is maintained as a laminar flow with the interaction with the exhaust fan 131, and thus the air blowing distance of the air flow is increased.

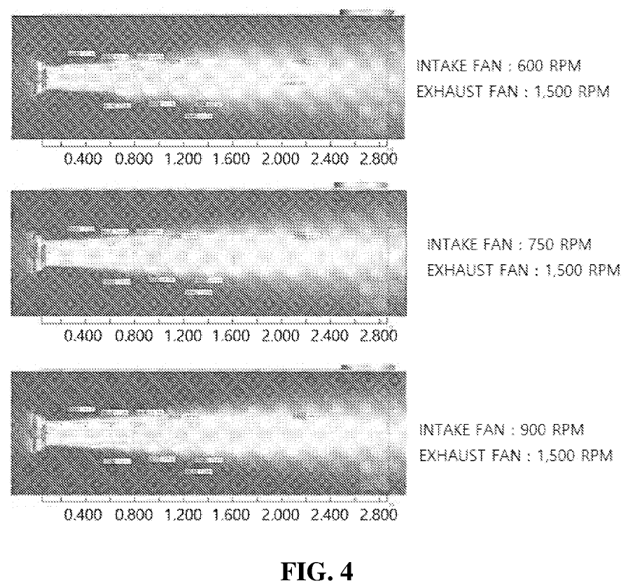

As illustrated in FIG. 4, experiments were performed to calculate optimum rotational speeds (RPM) of the intake fan 121 and the exhaust fan 131, using the air circulator 100 having a dual rotary vane according to the present invention which is configured as described above.

As a basic condition, the rotational speed of the intake fan was set to 750 RPM, the rotational speed of the exhaust fan was set to 1,500 RPM, and then simulations were performed on the straightness of the air flow while increasing and decreasing the rotational speeds of the respective fans.

(Experiment 1)

Intake fan: 600 to 900 RPM, Exhaust fan: 1,500 RPM

As a result of evaluating the straightness of the air flow while increasing and decreasing the rotational speed of the intake fan and fixing the rotational speed of the exhaust fan, the good straightness was exhibited when the rotational speed of the intake fan was 750 RPM or more.

TABLE 1

| Rotational speed of | Rotational speed of | Straightness |
|---|---|---|
| intake fan (RPM) | exhaust fan (RPM) | of air flow |
| 600 | 1,500 | Defective |
| 750 | 1,500 | Good |
| 900 | 1,500 | Good |

The good straightness was exhibited in both the cases in which the rotational speeds of the intake fan were 750 RPM and 900 RPM, and the air blowing distance of the air flow was exhibited similarly. In this case, the highest efficiency will be implemented when the rotational speed of the intake fan is 750 RPM at which consumption of power for driving the intake fan is low.

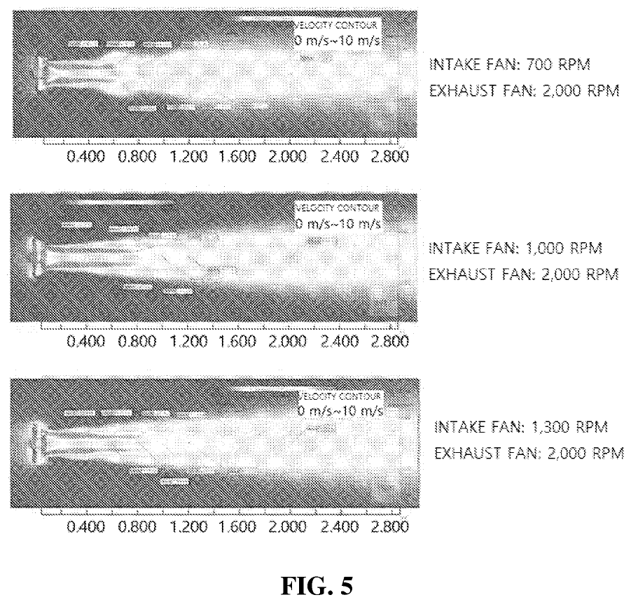

As illustrated in FIG. 5, experiments were performed to calculate optimum rotational speeds (RPM) of the intake fan 121 and the exhaust fan 131, using the air circulator 100 having a dual rotary vane according to the present invention which is configured as described above.

(Experiment 2)

Intake fan: 700 to 1,300 RPM, Exhaust fan: 2,000 RPM

TABLE 2

| Rotational speed of | Rotational speed of | Straightness |
|---|---|---|
| intake fan (RPM) | exhaust fan (RPM) | of air flow |
| 700 | 2,000 | Defective |
| 1,000 | 2,000 | Good |
| 1,300 | 2,000 | Good |

As a result of evaluating the straightness of the air flow by increasing and fixing the rotational speed of the exhaust fan to 2,000 RPM and increasing and decreasing the rotational speed of the intake fan, the good straightness was exhibited when the rotational speed of the intake fan was 1,000 RPM or more. The good straightness was exhibited in both the cases in which the rotational speeds of the intake fan were 1,000 RPM and 1,300 RPM, and the air blowing distance of the air flow was exhibited similarly. In this case, the highest efficiency will be implemented when the rotational speed of the intake fan is 1,000 RPM at which consumption of power for driving the intake fan is low.

As described above with reference to the above-mentioned experiments, the straightness of the air flow and the power efficiency were good when the rotational speed of the exhaust fan was twice the rotational speed of the intake fan.

A ratio of the rotational speed (RPM) of the intake fan to the rotational speed (RPM) of the exhaust fan was appropriately 1:2. Assuming that the rotational speed of the intake fan is R1 and the rotational speed of the exhaust fan is R2, R1:R2 may be advantageously 1:1.5 to 1:1.7, more preferably, 1:1.7 to 1:2, and most preferably, 1:2.

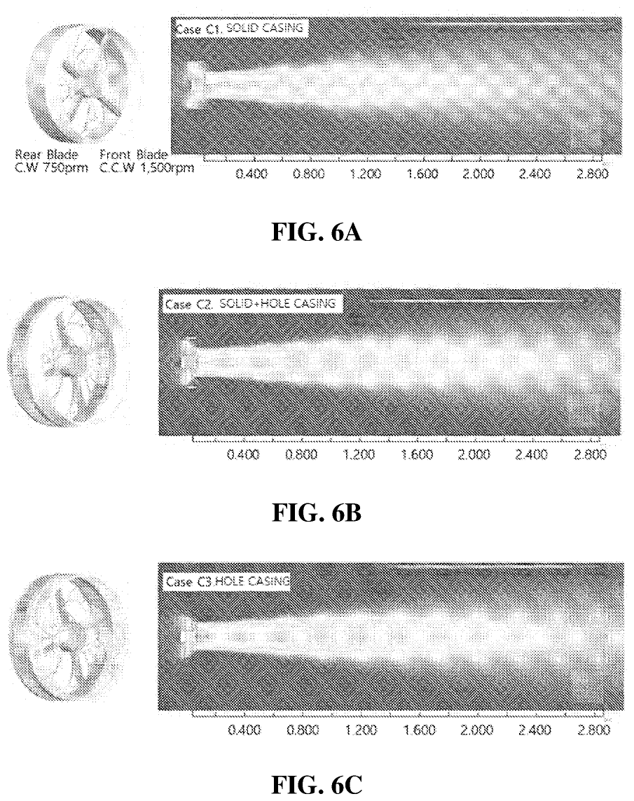

Meanwhile, referring to FIGS. 6A, 6B, and 6C, the air circulator 100 according to the present invention has the structure in which the intake holes or the exhaust holes are formed in the outer circumferential surface of the casing assembly 110, and this structure may minimize the occurrence of the vortex in the casing assembly 110. FIGS. 6A, 6B, and 6C are views illustrating results of performing experiments on the straightness of the air flow and the occurrence of the vortex in accordance with the structure of the casing assembly 110.

FIG. 6A illustrates a result of evaluating straightness of an air flow in a solid casing in which neither intake hole nor exhaust hole is formed in the outer circumferential surface of the casing assembly 110, FIG. 6B illustrates a result of evaluating straightness of an air flow in the casing assembly 110 having the intake holes formed in the outer circumferential surface of the intake fan casing 111, and FIG. 6C illustrates a result of evaluating straightness of an air flow in the casing assembly 110 in which the intake holes are formed in the outer circumferential surface of the intake fan casing 111 and the exhaust holes are formed in the outer circumferential surface of the exhaust fan casing 112.

The experiments were performed on the three casing assemblies under the same condition in which both the intake fan and the exhaust fan were operated, the intake fan was rotated at 750 RPM, the exhaust fan was rotated at 1,500 RMP, and the intake fan and the exhaust fan were rotated in opposite directions.

As a result of evaluating the solid casing illustrated in FIG. 6A, the straightness of the air flow was implemented, but the air blowing distance was comparatively short. In the case of the casing assemblies illustrated in FIGS. 6B and 6C, the good straightness and the good air blowing distance were implemented.

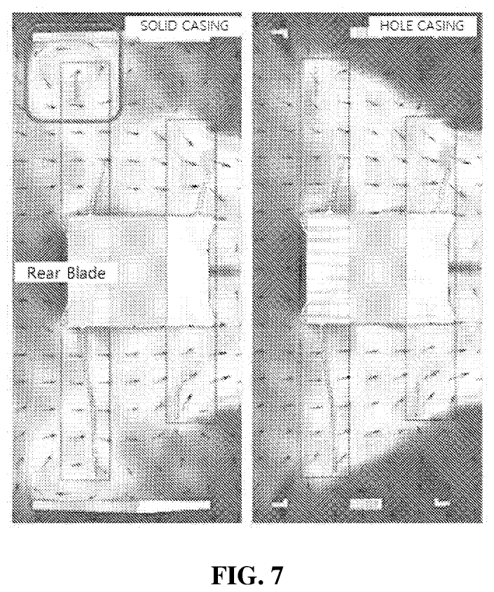

As illustrated in FIG. 7, it can be ascertained that the vortex occurs in the solid casing due to flow interference in the casing, and a part of the laminar flow is changed due to the influence of the vortex, and as a result, the air blowing distance is decreased. In contrast, in the case of the casing assembly in which the intake holes are formed in the intake fan casing or in the case of the casing assembly in which the intake holes and the exhaust holes are formed in both the intake fan casing and the exhaust fan casing, respectively, the vortex caused by the flow interference is eliminated, such that the straightness of the air flow and the air blowing distance may be good.

While the exemplary embodiments of the present invention have been described above, the spirit of the present invention is not limited to the exemplary embodiments presented in the present specification, those skilled in the art, who understand the spirit of the present invention, may easily propose other exemplary embodiments by adding, changing, deleting constituent elements within the same spirit and scope of the present invention, and it can be said that the exemplary embodiments are also within the spirit and scope of the present invention.

### DESCRIPTION OF MAIN REFERENCE NUMERALS OF DRAWINGS

100: Air circulator
110: Casing assembly
111: Intake fan casing
111a: Intake hole
112: Exhaust fan casing
112a: Exhaust hole
113: Support body
120: Intake fan assembly
121: Intake fan
122: Intake fan hub
123: Intake blade
130: Exhaust fan assembly
131: Exhaust fan
132: Exhaust fan hub
133: Exhaust blade

1. An air circulator having a dual rotary vane, the air circulator comprising:
a casing assembly having a suction port through which air is introduced, and a discharge port through which the air is discharged;
an intake fan assembly comprising an intake motor fixedly coupled in the casing assembly, and an intake fan configured to be rotatably driven by the intake motor; and
an exhaust fan assembly comprising an exhaust motor fixedly coupled in the casing assembly, and an exhaust fan configured to be rotatably driven by the exhaust motor and having a rotation radius smaller than a rotation radius of the intake fan,
wherein a rotational speed of the exhaust fan is higher than a rotational speed of the intake fan.

2. The air circulator of claim 1, wherein when the rotational speed of the intake fan is R1 and the rotational speed of the exhaust fan is R2, R1:R2 is 1:1.5 to 1:1.7.

3. The air circulator of claim 1, wherein when the rotational speed of the intake fan is R1 and the rotational speed of the exhaust fan is R2, R1:R2 is 1:1.7 to 1:2.

4. The air circulator of claim 1, wherein when the rotational speed of the intake fan is R1 and the rotational speed of the exhaust fan is R2, R1:R2 is 1:2.

5. The air circulator of claim 1, wherein when the rotational speed of the intake fan and the rotational speed of the exhaust fan are changed so that an air blowing distance of an air flow discharged from the casing assembly is constant, a low ratio of the rotational speed of the exhaust fan to the rotational speed of the intake fan is selected so that power consumption of the intake motor and the exhaust motor is decreased.

6. The air circulator of claim 1, wherein the casing assembly has a plurality of intake holes through which outside air is introduced, and the plurality of intake holes is formed adjacent to the suction port and disposed along an outer circumferential edge of the casing assembly.

7. The air circulator of claim 1, wherein the casing assembly comprises:
an intake fan casing configured to receive the intake fan assembly;
an exhaust fan casing configured to receive the exhaust fan assembly; and
a support body fixedly coupled to the intake fan casing between the intake fan casing and the exhaust fan casing and configured to fix and support the intake fan assembly and the exhaust fan assembly, and
wherein a plurality of intake holes through which outside air is introduced is formed at one side and an outer circumferential edge of the intake fan casing.
